(19) United States
(12) Patent Application Publication
(10) Pub. No.: US 2016/0249422 A1
(43) Pub. Date: Aug. 25, 2016

(54) Emitting Power of A Bulb Is Controlled By Regular Power OnOff Switch and The Power Level Can Be Learned

(71) Applicants: Wen-Chau Wayne Hou, Cupertino, CA (US); Gary Jun Liang Lin, San Jose, CA (US); Ekram Bhuiyan, San Jose, CA (US)

(72) Inventors: Wen-Chau Wayne Hou, Cupertino, CA (US); Gary Jun Liang Lin, San Jose, CA (US); Ekram Bhuiyan, San Jose, CA (US)

(21) Appl. No.: 14/629,496

(22) Filed: Feb. 24, 2015

(51) Int. Cl. H05B 33/08; F21V 23/00; H05B 41/392

(52) U.S. Cl. CPC H05B 33/0815; H05B 33/0845; H05B 41/3927; F21V 23/003

(57) ABSTRACT

A new type of light bulb is being invented, in which its power level (dimming) control circuit (FIG. 2) is integrated with the bulb. The desired power level can also be learned through the control logic (FIG. 3) integrated with bulb. The new invented bulb can be a compact fluorescent type 100 of bulb or a LED type of bulb 101. The invented bulb can be connected to an existing lamp holder (screw type) and people can change its power level (dimming) by only using the existing switch without any external circuit or device.

A new type of light bulb was invented; it has its power level control and power level memorization (PowerLearn Technology) circuits built inside or connected to the bulb. The new invented bulb can be a compact fluorescent bulb 100 (as shown in FIG. 1), an LED bulb 101 (as shown in FIG. 1), or any kind of electricity powered bulbs. The invention is to design and include a special circuit inside the bulb where the power consumption level (dimming) of the bulb can be controlled and memorized by utilizing the regular power on/off switch without involving any kind of external dimming controller box or circuits. The power level control circuit is accomplished by using the flash memory (or any nonvolatile memories) and a controller (as shown in FIG. 2). The invented bulb can have a traditional screw head, a pin head or any kind of electrical connector. The invented bulb seamlessly replaces any kind of bulb.

### FIELD OF THE INVENTION

This invention relates generally to the field of apparatus for an electrical light bulb. Moreover it pertains specifically to such apparatus for bulb power level (dimming) control by using the existing switch without addition circuitry. Also, the desired power level can be memorized after achieving the power learning procedure. In the near future, we believe the energy saving bulb will be the major lighting device. The invented bulb provides a way to integrate one of the key features into the bulb without any changes to the wiring infrastructure of the house. Through the existing switch, the power level (dimming, lumen) of the bulb can be changed at a discrete percentage to save energy. The discreet power levels control of the invented bulb can be designed to dim from brightest to darkest or vice-versa through a continuous flipping of the power switch.

The power level (dimming) control of the invented bulb is accomplished through the usage of one or multiple nonvolatile memory/memories and the controller circuit. On FIG. 2, a circuit block diagram of the bulb power (dimming) control is illustrated. A rectifier circuit 200, connected to a power supply through a power switch for converting an input AC voltage to a DC voltage. The DC voltage is then provided to the lamp drive circuit 203, the flash and PWM controller 202, the flash memory 201, and the current of the lamp 204. The method for changing the power level (dimming) of the bulb is to apply a Pulse Width Modulation (PWM) voltage to the lamp drive circuit. The bulb current is proportional to the duty cycle of the PWM signal. So, by adjusting the PWM duty cycle, the bulb current (turn out to be the bulb power level) can be changed and controlled. The invention is to use one or more nonvolatile memory and the controller circuit to achieve the adjustment of the PWM duty cycle whenever the power switch is continuously turned on and off.

The power level memorization is accomplished through power learning procedure. One approach to design the power learning circuit can be involving a logic counter, a wait time register, and a state machine to issuing the read/write/erase commands to the flash memory. Whenever the power switch is on, the counter starts to count. Before the power switch is turned off, if the counter reaches the amount that is specified in the wait time register, the state machine of the controller will issue a write command with current PWM duty cycle control data to the nonvolatile memory. Once the write command is completed, the current power level is learned (memorized) by the bulb circuit and stored into the nonvolatile memory. If the power is turned off before the counter reaching the amount in the wait time register, no PWM duty cycle control data will be written to the nonvolatile memory.

### SUMMARY OF THE INVENTION

In view of the limitations now present in the prior art, the presented invention provides a new type of light bulb which has the power level control and learning capability integrated into the bulb. The invented bulb can be used in any existing lamp holder, (screw type or any other types) and people can change its power level (dimming) by using the existing power on/off switch. With the invented bulb, no external dimming control circuit is required to change its brightness; everything works through the existing regular power on/off switch infrastructure.

The bulb can be any of the following types of bulbs: compact fluorescent 100, the LED 101 or any electricity powered bulb. The main advantage of the invented bulb is that people can change its brightness according to the needs of the environment and at the same time, save electrical power without having any changes to the existing electrical wiring and circuit.

The ways to incorporate the power level (dimmable) control into the bulb can be multifarious. The integrated controller or adapter based on the signal (power switch on/off sequences) determines the power level or lumens and controls the power accordingly. The power level adjustment in the invention is accomplished by using one or more nonvolatile memory 201 and a controller/device 200,202,203. Any power level (dimming) control of one or multiple bulb/bulbs through the use of the existing switch and the usage of a nonvolatile memory 201 and a controller 200,202,203 are covered by this patent. The power level learning technology that described in the document is also covered by this patent.

The technique to control the power level (dimming) of the bulb in this invention is to use the preserved data to adjust the duty cycle of the PWM signal. The preserved data can be stored in a dedicated flash memory 201 or any nonvolatile memories, which will retain the updated PWM duty cycle control data whenever the power is off.

Following is an example sequence to describe how the PWM duty cycle can be adjusted by turning on and off the power switch and turn out to control the power level (dimming) of the bulb.
At first time power on, the preserved data in the flash memory is read through the flash memory controller and to set the PWM with a maximum (brightest) or a minimum (darkest) duty cycle.
The bulb current is driven to be the maximum value (brightest) or the minimum (darkest) by the PWM voltage.
At this time, the flash memory controller 202 calculates the PWM driving data to be the next bright or dark level value and the state machine writes the updated PWM duty cycle data back to the flash memory 201. This step completes in a very short time.
At the moment, when the power switch is turned off, the next bright or dark level of the PWM duty cycle data has already been stored in the flash memory 201.
The power switch is turned on again. Now the data in the flash memory 201 is read again through the controller 202 and which is then used to drive the duty cycle of the PWM to the next bright or dark level, which turns out to drive the lumen of the bulb 204 to the next bright or dark level.
At this time, the flash memory controller 202 calculates the PWM driving data bits to be the next bright or dark level value again and saves the updated PWM duty cycle data bits back to the flash memory 201.
Continues with the above operation loop, all the discrete power levels of the bulb can be reached one by one.

Following is another example of sequence which describes how the current power level is learned by the bulb.
At first power on, the preserved data in the flash memory 201 is read through the flash memory controller 301 and to set the PWM pulse generator 304 with a maximum (brightest) or a minimum (darkest) duty cycle. The counter in the flash and PWM controller 202 (or FIG. 3) starts to count.
If the counter reaches the waiting time that is specified in the wait time register 300, the state machine 301 in the controller will issue a write to the flash memory with current PWM duty cycle data. Which turns out current power level of the bulb is learned or memorized in the flash memory 201.
When power switch is turned off and on again, the PWM duty cycle data in the flash memory is read by the state machine and is used to drive the power level of the bulb to the memorized power level.

### BRIEF DESCRIPTION OF THE DRAWINGS

The foregoing and other objects, features and advantages of the invention will be apparent from the following more particular description of preferred embodiments of the invention, as illustrated in the DRAWING section, in which like reference characters refer to the same parts throughout different views. The drawings are not meant to limit the invention to particular mechanisms for carrying out the invention in practice, but rather, the drawings are illustrative of certain ways of performing the invention.

FIG. 1. shows the invented bulb has a regular screw head, and the bulb type can be the compact fluorescent bulbs (CFL) or the light-emitting diode bulbs (LED).

FIG. 2. shows a block diagram of the bulb power level (dimming) control circuit. The major blocks include: the rectifier circuit, the flash and PWM controller, the bulb driving circuit, and the flash memory.

FIG. 3. shows the functional blocks of the “flash and PWM controller”. It includes: the IO interface, the wait timer, the control register file, the flash memory control state machine and logic, and the PWM pulse generator.

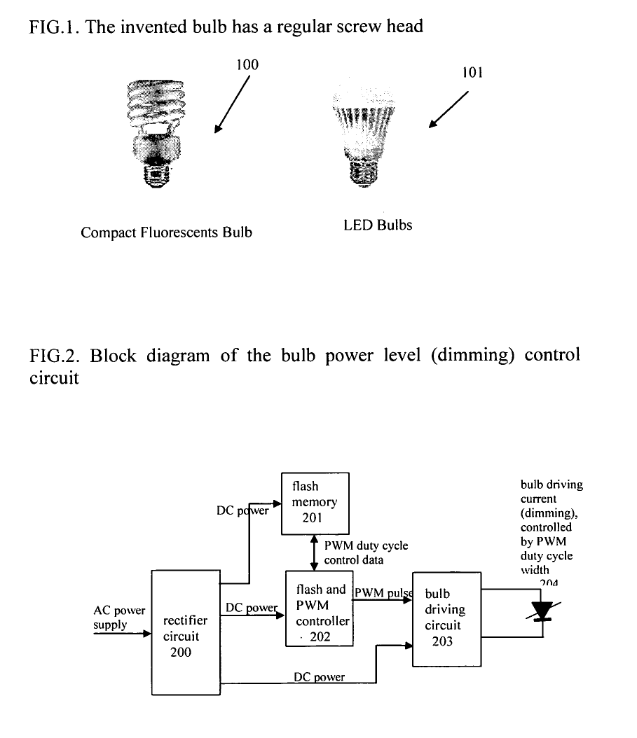

### DETAILED DESCRIPTION OF THE INVENTION

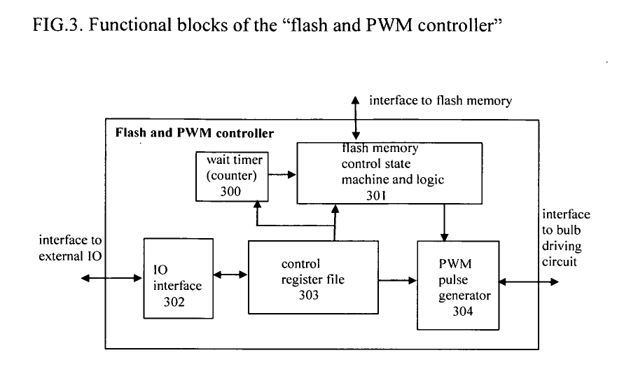

The invented bulb has included two major electrical components in its circuit board design, the “flash and PWM controller 202” and the “flash memory 201” as shown in FIG. 2). The “flash and PWM controller 202” is further described in FIG. 3.

The “flash and PWM controller 202” module includes few major blocks, IO interface 302, control register file 303, wait timer (counter) 300, flash memory control state machine and logic 301, and the PWM pulse generator 304.

The IO interface block 302 provides the path for the programmability of the control register file 303 from external of the bulb. In simple bulb design, since there is no external IO interface 302 designed, the registers inside the control register file 303 will be hard coded to a certain value. The IO interface block 302 is reserved in the design for advanced intelligent bulb programming capability.

The control register file 303 includes a few registers which are used to control the flash interface state machine 301, the wait timer 300, and the PWM pulse generation 304. For example, there is a learning wait time register which is used to specify the total wait time before the flash control state machine 301 issuing the current power level learning (memorization) command to the flash memory 201 after power on.

The flash memory control state machine block 301 is mainly used to control the write/read accesses to the flash memory 201. There is a main state machine inside the flash memory control state machine block 301 which is designed to generate all the flash memory assessing commands (such as write, read, erase, etc) based on different conditions. For example, when the wait timer 300 reaches the programmed “learning wait time” in the wait time register, the state machine will issue a write command with current power level PWM duty cycle data to the flash memory 201 to learn (memorize) the current power (dimming) level.

The wait timer block 300 is a simple counter. When the power is on, it starts to count. When it reaches the value that is specified in the wait time register, it sends a signal to inform the flash memory control state machine 301 to issue a power learned command to the flash memory 201.

The PWM pulse generator block 304 controls the duty cycle of the PWM pulse that is sent to the bulb driving circuit 203 and turns out to control the power level (dimming) of the bulb. The generated duty cycle width is based on the inputs PWM pulse data from the flash memory control state machine and logic block 301 (as shown in FIG. 3).

With the control circuit described above, the bulb's power level (dimming) control by using the regular power on/off switch and the power level (dimming) learning (memorization) can be achieved with following sequences:

Power level (dimming) control sequence by continuously turning on and off of the power switch:
At first time power on, the preserved data in the flash memory 201 is read through the flash memory controller 202 and to set the PWM with a maximum (brightest) or a minimum (darkest) duty cycle.
The bulb current 204 is driven to be the maximum value (brightest) or the minimum (darkest) by the PWM voltage.
At this time, the flash memory controller 202 calculates the PWM driving data to be the next bright or dark level value and the state machine 301 writes the updated PWM duty cycle data back to the flash memory 201. This step completes in a very short time.
At the moment, when the power switch is turned off, the next bright or dark level of the PWM duty cycle data has already been stored in the flash memory 201.
The power switch is turned on again. Now the data in the flash memory 201 is read again through the controller 202 and which is then used to drive the duty cycle of the PWM to the next bright or dark level, which turns out to drive the lumen of the bulb 204 to the next bright or dark level.
At this time, the flash memory controller 202 calculates the PWM driving data bits to be the next bright or dark level value again and saves the updated PWM duty cycle data bits back to the flash memory 201.
Continues with the above operation loop, all the discrete power levels of the bulb can be reached one by one.

Current power level (dimming) learning (memorization) sequence:
At first power on, the preserved data in the flash memory 201 is read through the flash memory controller 202 and to set the PWM with a maximum (brightest) or a minimum (darkest) duty cycle. The counter 300 in the flash and PWM controller 202 starts to count.
If the counter 300 reaches the waiting time that is specified in the wait time register, the state machine 301 in the controller will issue a write to the flash memory 201 with current PWM duty cycle data. Which turns out that the current power level of the bulb is learned or memorized in the flash memory 201.

What is claim is:

1. A new type of light bulb, comprising:
Integration of a power level (dimming) control circuit;
The dimming control of the bulb is achieved by turning on off the regular power switch. No change to the existing wiring infrastructure is required for controlling the dimming of the bulb.

2. The light bulb of claim 1, has an intelligent dimming controller circuit built in.

3. The light bulb of claim 1, is able to changing the dimming, lumen levels by using existing regular power on off switch without involving any external dimming control circuits.

4. The light bulb of claim 1, its power level (dimming) can be controlled from a maximum brightness to a minimum brightness or vice-versa.

5. The light bulb of claim 1, has the flash memory or nonvolatile memories included in the dimming control circuit, which is used to memorize different PWM duty cycle data for the discrete dimming levels.

6. The method comprising of the power learn capability built into the light bulb. The lumen level or light intensity level will be stored after the light bulb is turned on for a preset amount of time.

7. The light bulb of claim 6, has the power learn capability, which is accomplished through the usage of a flash memory (or any nonvolatile memory), the controller, and a certain operation sequence.

8. The light bulb of claim 6, uses the flash memory or any nonvolatile memory to store the preserved PWM duty cycle control data and to achieve the discrete power level (dimming) control purpose.
